(19) United States
(12) Patent Application Publication
(10) Pub. No.: US 2026/0322495 A1
(43) Pub. Date: Oct. 15, 2026

(54) AN IMPROVED TELECOMMUNICATIONS ACCESS NETWORK

(71) Applicant: British Telecommunications Public Limited Company, London Greater London (GB)

(72) Inventor: Andrew LORD, London Greater London (GB)

(21) Appl. No.: 19/122,625

(22) PCT Filed: Sep. 13, 2023
(86) PCT No.: PCT/EP2023/075194

§ 371 Date: Apr. 18, 2025

(30) Foreign Application Priority Data
Oct. 28, 2022 (EP) 22204494.3

(51) Int. Cl. H04B 10/291; H04B 10/296

(52) U.S. Cl. CPC H04B 10/2912; H04B 10/296

(57) ABSTRACT

There is herein provided a method of operating a telecommunications access network having a head end and a remote end, the head end and a remote end being adapted for optical data transmission therebetween via an optical amplifier, the head end having access to a schedule of transmission information relating to a plurality of data transmissions scheduled to occur between the head end and the remote end, the method comprising, at the head end, obtaining, from the schedule of transmission information, information relating to one of the plurality of data transmissions between the head end and the remote end; using the obtained information to determine an amount of pump power to be supplied to the optical amplifier; supplying the determined amount of pump power from a power source to the optical amplifier; transmitting the one of the plurality of data transmissions between the head end and the remote end via the optical amplifier.

Passive Optical Networks (PONs) can be used in access networks providing internet and telephone services to residential and business customers. Such PONs comprise optical fibres linking the customer equipment, via a passive splitter, to a local exchange. The local exchange is in turn connected to a central exchange.

For reasons of cost-saving, in recent times there has been a drive to reduce the number of local exchanges. This has led to the use of PONs in which the customer equipment is connected by optical fibre, directly to the central exchange. As there are relatively few central exchanges, this optical fibre connection must be relatively long. This results in the attenuation of the optical signals, which reduces transmission quality and hence customer experience. It would be desirable to provide a PON for use in an access network in which the customer equipment can be connected directly to the central exchange without a significant reduction in transmission quality.

The present invention provides a method in which these and/or other disadvantages of the prior art are overcome and/or substantially mitigated.

According to a first aspect of the invention there is provided a method of operating a telecommunications access network having a head end and a remote end,
The head end and remote end being adapted for optical data transmission therebetween via an optical amplifier,
The head end having access to a schedule of transmission information relating to a plurality of data transmissions scheduled to occur between the head end and the remote end,
The method comprising, at the head end, obtaining, from the schedule of transmission information, information relating to one of the plurality of data transmissions between the head end and the remote end;
Using the obtained information to determine an amount of pump power to be supplied to the optical amplifier;
Supplying the determined amount of pump power from a power source to the optical amplifier;
Transmitting the one of the plurality of data transmissions between the head end and the remote end via the optical amplifier.

Embodiments of the invention enable a method to be performed in which the power of the optical amplifier can be adjusted for each incoming transmission using a schedule of transmissions. The attenuation of an optical signal depends on factors such as transmission path length. This means, for example, that the signals from remote Optical Network Units (ONUs) will have a lower signal power at the optical amplifier than signals from less remote ONUs. Receiving signals of varying power can cause harmful “transients” in the amplifier, increasing the “dead time” that must be allowed between transmissions. Embodiments of the present invention enable the equalisation of signal power at the amplifier, reducing the occurrence of transients.

The head end may comprise a central exchange. The central exchange may be a metro node. The remote end may comprise an Optical Network Unit (ONU). The Optical Network Unit may be located at a customer premises. The remote end may comprise a plurality of Optical Network Units.

The one of the plurality of data transmissions may be transmitted from the remote end to the head end. Alternatively, the one of the plurality of data transmissions may be transmitted from the head end to the remote end.

The information relating to the one of the plurality of data transmissions may be information related to the power of the one of the plurality of data transmissions. The information relating to one of the plurality of data transmissions may comprise a path length for the transmission. The path length may be the distance from the head end to the Optical Network Unit. Alternatively, or in addition, the information relating to one of the plurality of data transmissions may comprise a transmission power of the Optical Network Unit. Alternatively, or in addition, the information relating to one of the plurality of data transmissions may comprise an amount of data contained in the one of the plurality of data transmissions.

The determined amount of pump power may be the amount of pump power required by the optical amplifier to amplify the one of the plurality of data transmissions such that:
(i) the one of the plurality of data transmissions has sufficient power to reach its destination; and/or
(ii) the power of the one of the plurality of data transmissions is substantially the same as the power of the remainder of the plurality of data transmissions between the head end and the remote end.

The schedule of transmission information may contain information relating to transmissions occurring between the head end and remote end over a period of time, which may be one hour, one day, one week or some other period of time. The schedule of transmission information may contain information relating to transmissions between the head end and a plurality of Optical Network Units. The plurality of Optical Network Units may comprise more than 10 Optical Network Units and may comprise more than 100 Optical Network Units. The schedule of transmission information may contain information relating to a plurality of future transmissions between the head end and the plurality of Optical Network Units. The plurality of future transmissions may comprise more than 10 transmissions, or more than 100 transmissions or more than 1000 transmissions.

The power source may be located in the central exchange. The power source may be a laser. The step of supplying the determined amount of pump power to the optical amplifier may take place over a dedicated supply channel, which may be a hollow core fibre. The hollow core fibre may be tuned so as to minimise losses at the wavelength of operation of the laser.

The pump power may be supplied to the optical amplifier over a hollow-core fibre arranged to carry the pump signal from a pump signal source to the gain material of the optical amplifier. The wavelength of the pump signal may be suitable for pumping the gain material such that it is capable of performing stimulated emission for amplifying the data signals. The hollow-core fibre may provide low signal attenuation over an operative range of wavelengths and the pump signal has a wavelength that is within the operative range of wavelengths.

According to a second aspect of the invention there is provided a head end of a telecommunications access network, the head end being adapted for optical data communication with a remote end of the telecommunications access network via an optical amplifier,
The head end comprising a schedule of transmission information relating to a plurality of data transmissions scheduled to occur between the head end and the remote end,
The head end further comprising a power controller, the power controller being adapted to:
   obtain, from the schedule of transmission information, information relating to one of the plurality of data transmissions between the head end and the remote end;
   determine an amount of pump power to be supplied to the optical amplifier using the obtained information;
   supply the determined amount of pump power from a power source to the optical amplifier.

According to a third aspect of the invention there is provided a telecommunications access network having a head end, a remote end and an optical amplifier,
The head end and remote end being adapted for optical data transmission therebetween via the optical amplifier,
The head end comprising a schedule of transmission information relating to a plurality of data transmissions scheduled to occur between the head end and the remote end,
The head end further comprising a power controller, the power controller being adapted to:
   obtain, from the schedule of transmission information, information relating to one of the plurality of data transmissions between the head end and the remote end;
   determine an amount of pump power to be supplied to the optical amplifier using the obtained information;
   supply the determined amount of pump power from a power source to the optical amplifier.

A specific embodiment of the invention will now be described, for illustration only and with reference to the appended drawings, in which:

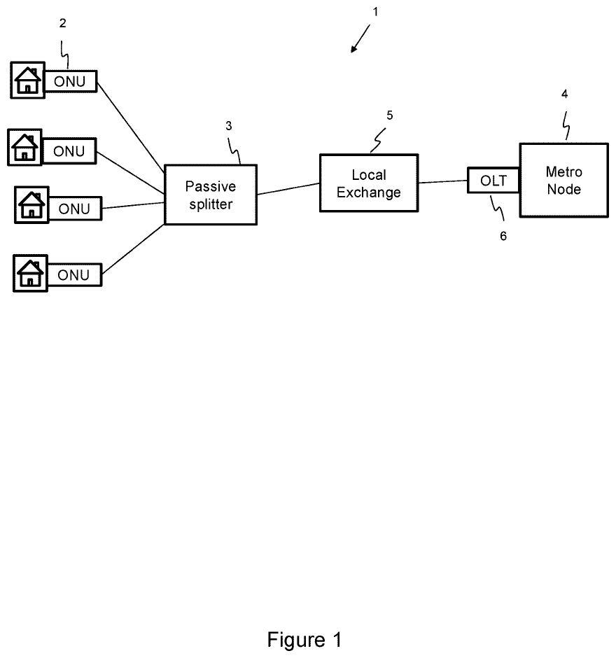

FIG. 1 is a schematic view of a known customer access network PON;

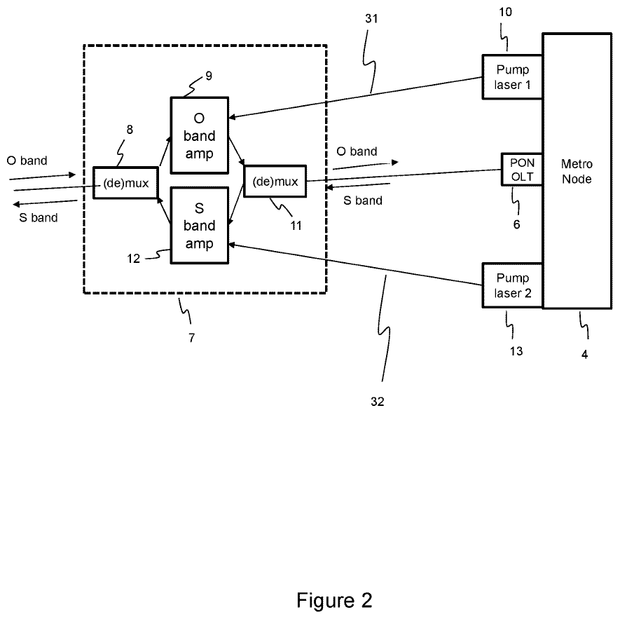

FIG. 2 is a schematic view of an optical amplifier of a PON configured to perform the method of the invention;

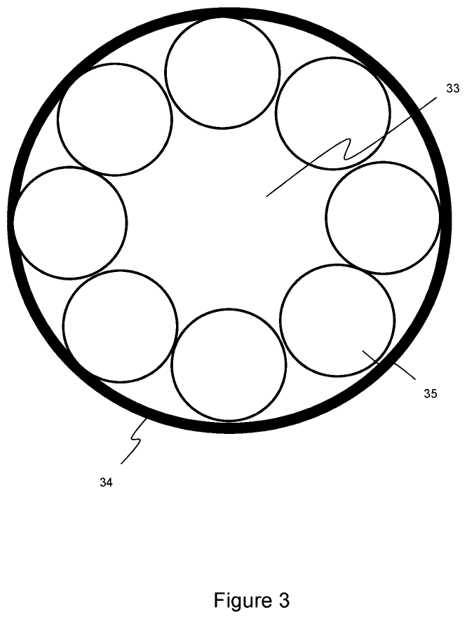

FIG. 3 is a schematic view of a hollow core fibre;

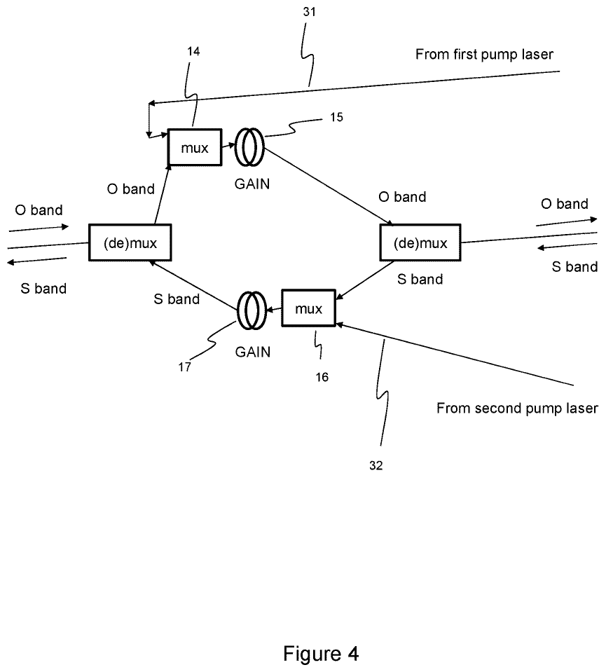

FIG. 4 a more detailed view of the optical amplifier of FIG. 2;

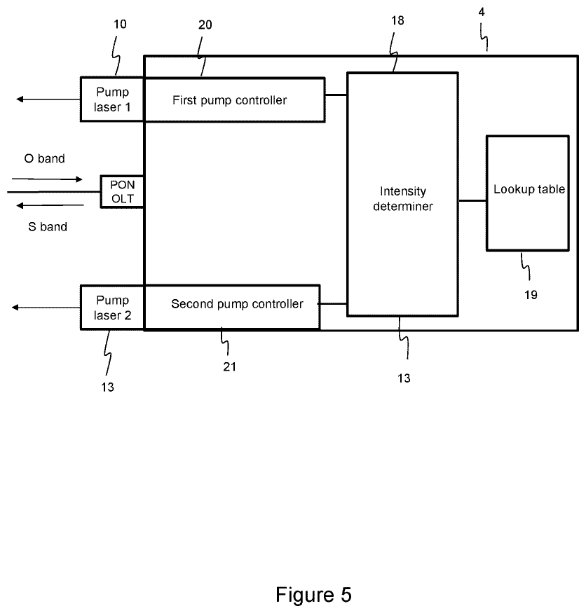

FIG. 5 is a schematic view of the components of a metro node of a PON configured to perform the method of the invention.

FIG. 1 shows a known PON 1 as part of an access network. Multiple ONUs 2 located in customer premises are connected by optical fibre to a passive splitter 3, which is connected by optical fibre to a local exchange 5. The local exchange 5 is connected to a central exchange, labelled as metro node 4. The local exchange 5 provides broadband services to the ONUs 2 over the optical fibres.

It may be desirable to dispense with the local exchange 5 and instead, connect the ONUs directly to the central exchange 4. This would remove the costs of setting up and running the local exchange, but has the disadvantage that the signals from the ONUs 2 have to travel a greater distance. This results in attenuation of those signals. The present invention addresses this.

FIG. 2 shows a PON in accordance with an embodiment of the invention. The ONUs (not shown) connect to the central exchange (referred to as the metro node 4) via an optical amplifier 7. The upstream signals (i.e. the signals transmitted by the ONUs to the metro node 4) have wavelengths in the O band. On arrival at the optical amplifier 7 they pass through a demultiplexer 8 which separates them from the downstream signals travelling in the opposite direction (i.e. the signals transmitted by the metro node 4 to the ONUs). The upstream signals then pass through an O band amplifier 9. The O band amplifier 9 receives pump power from a first pump laser 10 located in the metro node 4 over a first hollow core fibre 31. The pump power pumps the gain material in the O band amplifier 9 so that the arrival of the upstream signals stimulate light emission from the gain material in the O band amplifier, amplifying the upstream signals. The amplified upstream signals then pass through a multiplexer 11 to enable them to share a fibre with downstream signals coming in the opposite direction. The upstream signals then arrive at an OLT 6 at the metro node 4.

The downstream signals (i.e. the signals transmitted by the metro node 4 to the ONUs) have wavelengths in the S band. On arrival at the optical amplifier 7 they pass through a demultiplexer 11 which separates them from the upstream signals travelling in the opposite direction. The downstream signals then pass through an S band amplifier 12. The S band amplifier receives pump power from a second pump laser 13 located in the metro node 4 over a second hollow core fibre 32. The pump power pumps the gain material in the S band amplifier 12 so that the arrival of the downstream signals stimulate light emission from the gain material in the S band amplifier, amplifying those downstream signals. The amplified downstream signals then pass through a multiplexer 8 to enable them to share a fibre with upstream signals coming in the opposite direction. The downstream signals then pass through a splitter (not shown) and arrive at the ONUs (not shown).

The first and second hollow core fibres are “tuned” to give low attenuation at the wavelength of the pump light. Hollow core fibres are known in the art and so their structure and function will not be described in detail here. However, in essence, a hollow core fibre provides light propagation with minimal attenuation for certain wavelengths, those wavelengths depending on the precise dimensions of the fibre. The hollow core fibres 31 and 32 can be of either the photonic bandgap type or the anti-resonant type.

A schematic view of a cross section through an example of an anti-resonant hollow core fibre is shown in FIG. 3. The fibre comprises a central hollow (i.e. air-filled core 33) surrounded by cladding. The cladding comprises an outer glass layer 34 and an inner layer of eight silica rods 35.

FIG. 4 shows the optical amplifier in more detail. In particular, FIG. 4 shows that the pump power received from the first pump laser (not shown) passes through the first hollow core fibre 31 and a multiplexer 14 to combine the pump light with the O band (upstream) signal. The multiplexer 14 outputs the pump light and upstream signal to the gain material 15 of the O band amplifier. Together the multiplexer 14 and gain material 15 define the O band amplifier 9 shown in FIG. 2. The pump power received from the second pump laser (not shown) passes through the second hollow core fibre 32 and a multiplexer 16 to combine the pump light with the downstream signal. The multiplexer 16 outputs the pump light and downstream signal to the gain material 17 of the S band amplifier. Together the multiplexer 16 and gain material 17 define the S band amplifier 12 shown in FIG. 2

In use, the ONUs transmit signals to the metro node according to a schedule. A copy of this schedule is contained in a lookup table. When the schedule indicates that a particular ONU is about to transmit a signal, the first pump laser transmits a burst of pump light (a pump burst) to the O band amplifier. This pumps the gain material in the O band amplifier. The ONU then transmits the scheduled signal, which passes through the O band amplifier. The now amplified signal has sufficient power to reach the metro node.

FIG. 5 is a schematic representation of the components for controlling the pump power within the metro node 2. In particular, the metro node 2 contains an intensity determiner 18, a lookup table 19, a first pump controller 20 and a second pump controller 21. As noted, the lookup table 19 contains a schedule of forthcoming transmissions from the ONUs. This includes the time at which each ONU will transmit scheduled signals and the amount of data that each ONU will transmit in the scheduled transmission. The lookup table also contains the length of the fibre connecting each ONU to the optical amplifier.

The first 20 and second 21 pump controllers are operable to control the output intensity of the first 10 and second 13 pump lasers respectively. The remote node is able to control the output intensity of the first 10 and second 13 pump lasers depending on information contained in the lookup table 19 concerning the transmitting ONU.

In use, the intensity determiner 18 reads from the lookup table 19 to determine which ONU will be the next to transmit an upstream signal. The intensity determiner 18 also reads the length of the fibre to which the next ONU to transmit is connected. Using this length, the intensity determiner determines the gain required to be applied to the signal by the O band amplifier 9 to overcome the attenuation that the signal will suffer. The intensity determiner then determines the amount of laser pump power required to provide the determined gain and instructs the first pump laser 10 to transmit pump light to the O band amplifier 9 at the determined power. The first pump laser 10 then does so, and the upstream signal is transmitted and then amplified to the determined extent.

Take the example in which the lookup table indicates that one of the most remote ONUs will be the next ONU to transmit. This means that the signal transmitted by the ONU will likely be fairly heavily attenuated by the time it reaches the optical amplifier 7. The instructs the first pump controller 20 to transmit a pump burst of larger than average intensity to the O band amplifier 9. This high intensity pump burst provides the O band amplifier a gain which is larger than that provided by a pump burst of average intensity. The resulting output signal is more heavily amplified than the average signal.

Conversely, if the lookup table 19 indicates that one of the least remote ONUs will be the next to transmit, the signal transmitted by the ONU will likely be only lightly attenuated by the time it reaches the optical amplifier 9. The processor 18 instructs the first pump controller 20 to transmit a pump burst of smaller than average intensity to the O band amplifier. This lower-intensity pump burst provides the O band amplifier 9 a gain which is smaller than that provided by a pump burst of average intensity. The resulting output signal is less heavily amplified than the average signal.

This method of adjusting the intensity of the pump signal in accordance with the degree of attenuation suffered by the upstream signal causes the signals output by the O band amplifier 9 to be of more uniform intensity. This reduces the harmful transients suffered by the O band amplifier and reduces the “dead time” that must be allowed between successive transmissions.

A similar process is followed in relation to the downstream signals. In particular, the intensity determiner 18 reads from the lookup table 19 to determine which ONU will be the recipient of the next downstream signal to be sent from the metro node 4. The intensity determiner 18 also reads the length of the fibre to which that ONU is connected. Using this length, the intensity determiner determines the gain required to be applied to the signal by the S band amplifier 12 to overcome the attenuation that the signal will suffer. The intensity determiner 18 then determines the amount of laser pump power required to provide the determined gain and instructs the second pump laser 13 to transmit pump light to the S band amplifier 12 at the determined power. The second pump laser 13 then does so, and the downstream signal is transmitted and then amplified to the determined extent.

1. A method of operating a telecommunications access network having a head end and a remote end,
The head end and a remote end being adapted for optical data transmission therebetween via an optical amplifier,
The head end having access to a schedule of transmission information relating to a plurality of data transmissions scheduled to occur between the head end and the remote end,
The method comprising, at the head end, obtaining, from the schedule of transmission information, information relating to one of the plurality of data transmissions between the head end and the remote end;
Using the obtained information to determine an amount of pump power to be supplied to the optical amplifier;
Supplying the determined amount of pump power from a power source to the optical amplifier;
Transmitting the one of the plurality of data transmissions between the head end and the remote end via the optical amplifier.

2. A method as claimed in claim 1, wherein the head end comprises a central exchange.

3. A method as claimed in claim 1, wherein the remote end comprises an Optical Network Unit (ONU).

4. A method as claimed in claim 1, wherein the one of the plurality of data transmissions is transmitted from the remote end to the head end.

5. A method as claimed in claim 1, wherein the information relating to one of the plurality of data transmissions comprises a path length for the one of the plurality of data transmissions.

6. A method as claimed in claim 1, wherein the step of supplying the determined amount of pump power to the optical amplifier takes place over a dedicated supply channel.

7. A head end of a telecommunications access network, the head end being adapted for optical data communication with a remote end of the telecommunications access network via an optical amplifier,
The head end comprising a schedule of transmission information relating to a plurality of data transmissions scheduled to occur between the head end and the remote end,
The head end further comprising a power controller, the power controller being adapted to:
obtain, from the schedule of transmission information, information relating to one of the plurality of data transmissions between the head end and the remote end;
determine an amount of pump power to be supplied to the optical amplifier using the obtained information;
supply the determined amount of pump power from a power source to the optical amplifier.

8. A telecommunications access network having a head end, a remote end and an optical amplifier,
The head end and remote end being adapted for optical data transmission therebetween via the optical amplifier,
The head end comprising a schedule of transmission information relating to a plurality of data transmissions scheduled to occur between the head end and the remote end,
The head end further comprising a power controller, the power controller being adapted to:
obtain, from the schedule of transmission information, information relating to one of the plurality of data transmissions between the head end and the remote end;
determine an amount of pump power to be supplied to the optical amplifier using the obtained information;
supply the determined amount of pump power from a power source to the optical amplifier.

9. A computer-readable medium carrying instructions for carrying out the method as claimed in claim 1.
